(19) United States
(12) Patent Application Publication
(10) Pub. No.: US 2019/0196065 A1
(43) Pub. Date: Jun. 27, 2019

(54) ANTI-REFLECTIVE LENS AND METHOD FOR MANUFACTURING THE SAME

(71) Applicant: HON HAI PRECISION INDUSTRY CO., LTD., New Taipei (TW)

(72) Inventors: HSIU-WEN CHIEN, New Taipei (TW); WEN-KAI LI, New Taipei (TW)

(21) Appl. No.: 15/867,737

(22) Filed: Jan. 11, 2018

(30) Foreign Application Priority Data
Dec. 27, 2017 (TW) 106146098

(51) Int. Cl. G02B 1/118; C09D 5/00; C09D 5/02; C09D 143/04; C09D 5/16; G02B 1/04

(52) U.S. Cl. CPC G02B 1/118; C09D 5/006; C09D 5/028; C08K 2003/2241; C09D 5/1681; G02B 1/04; C09D 143/04

(57) ABSTRACT

An anti-reflective lens comprises a lens substrate and an anti-reflective layer formed on at least one surface of the lens substrate. The anti-reflective layer comprises a plurality of nano-structures spaced from each other. The plurality of nano-structures protrudes from the at least one surface of the lens substrate to form a compound-eye array. The anti-reflective layer is made of sol-gel composition. The disclosure also provides a method for manufacturing an anti-reflective lens.

### FIELD

The subject matter herein generally relates to an anti-reflective lens and a method for manufacturing the anti-reflective lens.

### BACKGROUND

Optical products such as spectacle lenses can be strongly reflective. But ghosting and flaring can occur, failing to give clear visibility. To prevent such reflection, anti-reflection films should be generally formed on the spectacle lenses.

### BRIEF DESCRIPTION OF THE DRAWINGS

Implementations of the present technology will now be described, by way of example only, with reference to the attached figures.

FIG. 1 is a diagrammatic view of an exemplary embodiment of an anti-reflective lens.

FIG. 2 is a cross-sectional view of the anti-reflective lens taken along II-II line of FIG. 1.

FIG. 3 is a flowchart of an exemplary embodiment of a method for making an anti-reflective lens.

FIG. 4 is a cross-sectional view of a mold used to make the anti-reflective lens of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising” when utilized, means “including, but not necessarily limited to”; it specifically indicates open-ended inclusion or membership in the so-described combination, group, series, and the like.

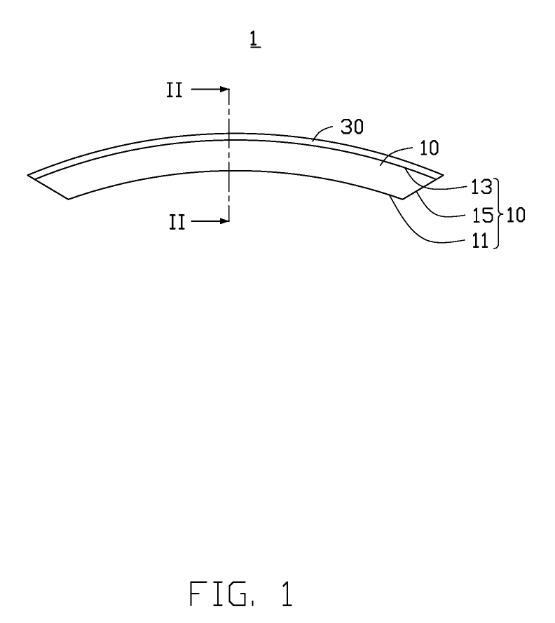

FIG. 1 illustrates a first exemplary embodiment of an anti-reflective lens 1. The anti-reflective lens 1 comprises a lens substrate 10 and an anti-reflective layer 30 coated on at least one surface of the lens substrate 10.

The lens substrate 10 comprises an inner surface 11, an outer surface 13 facing away from the inner surface 11, and a sidewall 15 connected between the inner surface 11 and the outer surface 13.

The lens substrate 10 may be made of glass, polycarbonate, polymethyl methacrylate, or other transparent materials used to make lenses.

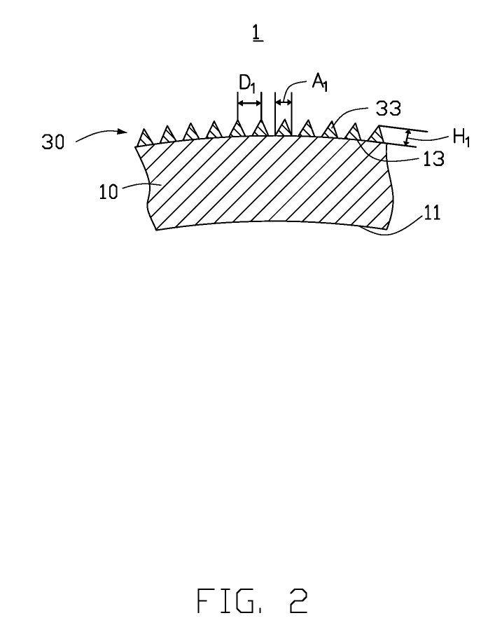

Referring to FIG. 2, the anti-reflective layer 30 comprises a plurality of nano-structures 33. The nano-structures 33 are spaced from each other. Each nano-structure 33 protrudes from at least one surface of the lens substrate 10, to cause the nano-structures 33 to form a compound-eye array. Each nano-structure 33 can be a conical structure or a hemispherical structure.

In at least one exemplary embodiment, each nano-structure 33 has a width on the surface of the lens substrate 10 (labeled as “A₁”) of about 35 nm to about 555 nm, and a highest point of each nano-structure 33 has a height (labeled as “H₁”) of about 40 nm to about 550 nm. A distance between the highest points of two adjacent nano-structures 33 (labeled as “D₁”) is about 36 nm to about 650 nm.

In at least one exemplary embodiment, the nano-structures 33 are formed on the whole of outer surface 13. In another exemplary embodiment, the nano-structures 33 may be formed on a part of the outer surface 13. Also, the nano-structures 33 may be formed on the whole of inner surface 11 or a part of the inner surface 11.

The nano-structures 33 are made by curing a sol-gel material.

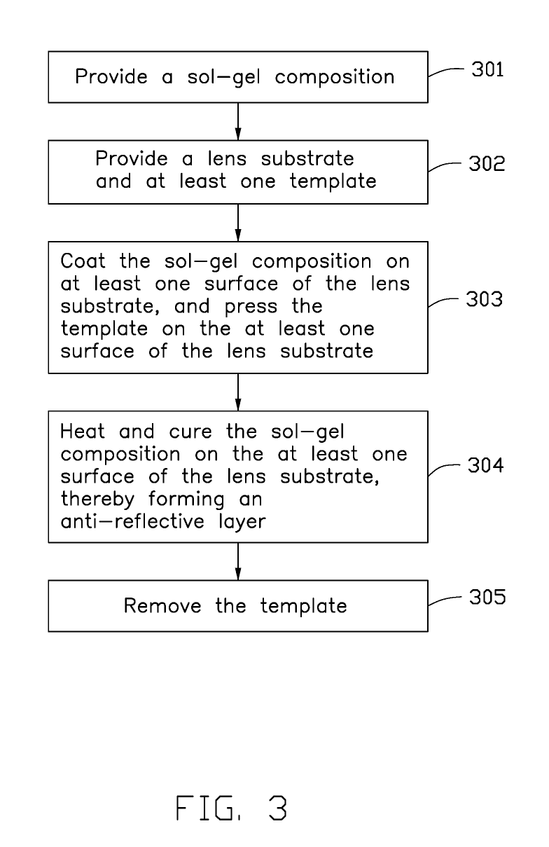

FIG. 3 illustrates a flowchart of an embodiment of a method for manufacturing an anti-reflective lens 1 in accordance with an exemplary embodiment. The exemplary method is provided by way of example, as there are a variety of ways to carry out the method. Each block shown in FIG. 3 represents one or more processes, methods, or subroutines, carried out in the exemplary method. Furthermore, the illustrated order of blocks is by example only, and the order of the blocks can change. Additional blocks may be added, or fewer blocks may be utilized, without departing from this disclosure. The exemplary method can begin at block 301.

At block 301, a sol-gel composition is provided.

The sol-gel composition comprises an organic component and an inorganic component. The organic component comprises an organic compound with silane group and an organic compound without silane group. The organic compound with silane group may be at least one of 3-(trimethoxusilyl)propyl methacrylate and methyl-trimethoxysilane. The organic compound without silane group may be at least one of methyl methacrylate and methacrylic acid. The inorganic component may be at least one of SiO2 and TiO2.

In at least one exemplary embodiment, the organic compound without silane group has a mass percentage of about 1.5% to about 62% of a total mass of the sol-gel composition. The organic compound without silane group has a mass percentage of about 16.8% to about 80.2% of a total mass of the sol-gel composition. The inorganic component has a mass percentage of about 18% to about 80% of a total mass of the sol-gel composition.

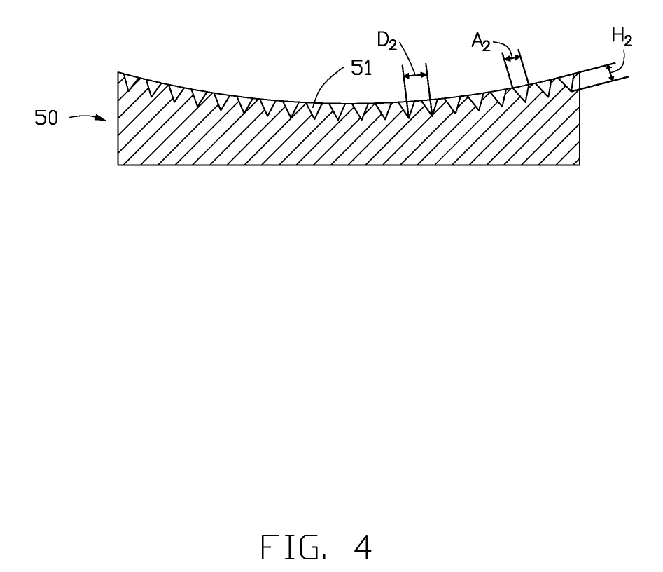

At block 302, referring FIGS. 1 and 4, a lens substrate 10 and at least one template 50 are provided. The template 50 comprises a plurality of nano-patterns 51. The nano-patterns 51 are spaced from each other. The template 50 corresponds to at least one surface of the lens substrate 10.

The lens substrate 10 comprises an inner surface 11, an outer surface 13 facing away from the inner surface 11, and a sidewall 15 connected between the inner surface 11 and the outer surface 13.

The lens substrate 10 may be made of glass, polycarbonate, polymethyl methacrylate, or other transparent materials used to make lenses.

The template 50 may be made of soft material or rigid material. In at least one exemplary embodiment, the template 50 corresponds to the outer surface 13 of the lens substrate 10.

Each nano-pattern 51 is recessed from a surface of the template 50 facing the lens substrate 10. Each nano-pattern 51 can be a conical groove or a hemispherical groove.

In at least exemplary embodiment, an opening of each nano-pattern 51 has a width (labeled as “A₂”) of about 35 nm to about 555 nm, and a lowest point of each nano-pattern 51 has a depth (labeled as “H₂”) of about 40 nm to about 550 nm. A distance between the lowest points of two adjacent nano-patterns 51 (labeled as “D₂”) is about 36 nm to about 650 nm.

At block 303, the sol-gel composition is coated on at least one surface of the lens substrate 10, and the template 50 is pressed on the sol-gel composition coated on lens substrate 10, to cause the sol-gel composition to fully infill the nano-patterns 51.

The sol-gel composition can be coated on the lens substrate 10 by dip coating or spin coating.

When the sol-gel composition is to be coated on the lens substrate 10 by dip coating, the lens substrate 10 is immersed in the sol-gel composition and taken out of the sol-gel composition at a rate of about 10 mm/min to about 350 mm/min. When the sol-gel composition is to be coated on the lens substrate 10 by spin coating, a rotation speed for the spin coating is kept between about 800 rpm and 5000 rpm.

In at least one exemplary embodiment, the sol-gel composition is coated on the whole of outer surface 13 of the lens substrate 10, and the template 50 is pressed on the entire outer surface 13. In another exemplary embodiment, the sol-gel composition is coated on a part of the outer surface 13. Also, the sol-gel composition may be formed on the whole of inner surface 11 or a part of the inner surface 11.

At block 304, the sol-gel composition coated on the lens substrate 10 is heated and cured, thereby forming an anti-reflective layer 30. The anti-reflective layer 30 is combined with the lens substrate 10. An anti-reflective lens 1 is thus obtained.

The anti-reflective layer 30 comprises a plurality of nano-structures 33 corresponding to the nano-patterns 51. The nano-structures 33 are spaced from each other. The plurality of nano-structure 33 protrudes from at least one surface of the lens substrate 10 to form a compound-eye array. Thereby, an anti-reflective property, a hydrophobic property, an anti-fouling effect, and an abrasion resistance to the anti-reflective lens 1 is achieved. Each nano-structure 33 can be a conical structure or a hemispherical structure.

In at least one exemplary embodiment, each nano-structure 33 has a width on the surface of the lens substrate 10 (labeled as “A₁”) of about 35 nm to about 555 nm, and a highest point of each nano-structure 33 has a height (labeled as “H₁”) of about 40 nm to about 550 nm. A distance between the highest points of two adjacent nano-structures 33 (labeled as “D₁”) is about 36 nm to about 650 nm.

In at least one exemplary embodiment, the lens substrate 10 with the sol-gel composition and the template 50 is heated to a temperature of about 55 degrees Celsius to about 140 degrees Celsius at a speed of 1° C./min. The final temperature is maintained for about 1 hour to about 12 hours. The sol-gel composition is thereby cured to form the anti-reflective layer 30, and the anti-reflective layer 30 is combined with the lens substrate 10.

At block 305, the template 50 is removed.

In another exemplary embodiment, the block 301 and the block 302 can be reversed in order.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A method for manufacturing an anti-reflective lens, comprising:
providing a sol-gel composition, a lens substrate, and at least one template, wherein each of the at least one template comprises a plurality of nano-patterns spaced from each other, the at least one template corresponds to at least one surface of the lens substrate, the plurality of nano-patterns is recessed from a surface of each of the least one template facing the lens substrate;
coating the sol-gel composition on the at least one surface of the lens substrate, and pressing the at least one template on the least one surface of the lens substrate to cause the sol-gel composition to fully infill the plurality of nano-patterns;
heating and curing the sol-gel composition coated on the at least one surface of the lens substrate, thereby forming an anti-reflective layer combined with the lens substrate, wherein the anti-reflective layer comprises a plurality of nano-structures corresponding to the plurality of nano-patterns, the plurality of nano-structures protrudes from the at least one surface of the lens substrate to form a compound-eye array; and
removing the template.

2. The method of claim 1, wherein each of the plurality of nano-patterns is a conical groove or a hemispherical groove, and each of the plurality of nano-structures is a conical structure or a hemispherical structure.

3. The method of claim 2, wherein each of the plurality of nano-structures has a width on the at least one surface of the lens substrate of about 35 nm to about 555 nm, a highest point of each of the plurality of nano-structures has a height of about 40 nm to about 550 nm, and a distance between the highest points of two adjacent nano-structures is about 36 nm to about 650 nm.

4. The method of claim 1, wherein the sol-gel composition is coated on the at least one surface of the lens substrate by dip coating or spin coating.

5. The method of claim 4, wherein when the sol-gel composition is coated on the at least one surface of the lens substrate by dip coating, the lens substrate is immersed in the sol-gel composition and taken out of the sol-gel composition at a rate of about 10 mm/min to about 350 mm/min.

6. The method of claim 4, wherein when the sol-gel composition is coated on the at least one surface of the lens substrate by spin coating, a rotation speed for the spin coating is kept between about 800 rpm and 5000 rpm.

7. The method of claim 4, wherein heating and curing the sol-gel composition coated on the at least one surface of the lens substrate further comprising:
heating the sol-gel composition coated on the at least one surface of the lens substrate to a temperature of about 55 degrees Celsius to about 140 degrees Celsius at a speed of 1° C./min, and then maintaining the temperature for about 1 hour to about 12 hours.

8. An anti-reflective lens comprising:
a lens substrate; and
an anti-reflective layer formed on at least one surface of the lens substrate;
wherein the anti-reflective layer comprises a plurality of nano-structures spaced from each other, the plurality of nano-structures protrudes from the at least one surface of the lens substrate to form a compound-eye array, the anti-reflective layer is made of sol-gel composition.

9. The anti-reflective lens of claim 8, wherein each of the plurality of nano-structures is a conical structure or a hemispherical structure.

10. The anti-reflective lens of claim 9, wherein each of the plurality of nano-structures has a width on the at least one surface of the lens substrate of about 35 nm to about 555 nm, a highest point of each of the plurality of nano-structures has a height of about 40 nm to about 550 nm, and a distance between the highest points of two adjacent nano-structures is about 36 nm to about 650 nm.
